(19) United States
(12) Patent Application Publication
(10) Pub. No.: US 2017/0243182 A1
(43) Pub. Date: Aug. 24, 2017

(54) Method of Visiting Online Banking Website and Browser

(71) Applicant: Beijing Qihoo Technology Company Limited, Beijing (CN)

(72) Inventors: Zhigang Hou, Beijing (CN); Hongyi Zhou, Beijing (CN)

(73) Assignee: Beijing Qihoo Technology Company Limited, Beijing (CN)

(21) Appl. No.: 15/314,824

(22) PCT Filed: May 27, 2015
(86) PCT No.: PCT/CN2015/079876

§ 371 Date: May 4, 2017

(30) Foreign Application Priority Data
May 30, 2014 (CN) 201410239295.8

(51) Int. Cl. G06Q 20/10; G06F 9/445

(52) U.S. Cl. CPC G06Q 20/108; G06F 8/61

(57) ABSTRACT

The present disclosure provides a method of visiting an online banking website and a browser, wherein the browser is adapted to visit an online banking website, and save an online banking website configuration file in the storing module of the browser. Regarding the implementing of the visiting method, when the webpage requesting information of a page website address is detected on the browser side, the browser firstly determines that the page website address is the website address information of the online banking website in the online banking website configuration file, and then initiatively initiates the downloading of a corresponding security plug-in on the online banking website and the installing program, so as to visit the corresponding online banking website via the security plug-in. Because the downloading of the security plug-in and the installing program are in advance completed by the browser before the webpage requesting information is transmitted to the online banking server, when the user is logging in the online banking server on the browser, the method can omit the operations of manually downloading and installing the security plug-in, and ensures the security when logging in the online banking server.

### FIELD OF THE INVENTION

The present disclosure relates to technical field of browsers, and in particular to a method of visiting an online banking website and a browser.

### BACKGROUND OF THE INVENTION

The rising of the Internet brings much convenience to the overall operation and management of banks. Due to the existing of the Internet, compared with traditional banks, which mainly rely on entity branches to expand their transact businesses and fields, currently most of banks operate by online banks, which largely expands their overall scope of business. Online banks indeed provide the clients with finance services at any time, at any place and in any manner. Such a model that provides service via online banking websites without limitations of time and place greatly satisfies demands of the clients, and thus has very rapid development.

Visiting an online banking website by a browser is an important step of the current Internet commerce or finance service. The browser users visit online banking websites and thereby perform operations such as transferring of account, depositing and buying exchange; however, those operations, which involve money, have higher requirement on network security than visiting common websites which are not online banking websites.

In order to ensure that online banking websites can be normally and safely used, all of the online banking websites develop corresponding security controls on the basis of the website architectures and security systems of themselves, and those security controls are saved on online banking servers. When a user logs in the online banking to perform operations that involve privacy and security such as transferring of account, depositing and buying exchange on an online banking website by a browser, the online banking server will feedback the installation information of the security control to the browser side, to prompt the user to install the security control on the browser so as to help the operations of inputting or outputting data, thereby realizing the safety interaction between the user side (that is, the browser side) and the online banking server.

However, currently, regarding the using of browsers, a problem that frequently rises is that, different online banking websites employ different security controls on a single browser. For example, in practice, the security controls that are used by the online banking websites of China Construction Bank and China Merchants Bank are of considerable difference. Meanwhile, due to the convenience of online banking websites, many users have accounts of a plurality of different online banking websites each; or, when a user is to pay on a shopping website that has entries of a plurality of online banking servers, the user is required to execute one time of operation of installing the corresponding security control when logging in each of the online banking websites by the browser, to normally use the functions provided by the online banking websites, as the result of which the user of the browser can safely use all the online banking websites only after tedious operations.

Meanwhile, regarding each type of finance services, the bank systems employ different security controls. For example, there are controls of controlling the security of log-in input, security controls of validating digital signatures at paying, security controls and anti-phishing plugs-in regarding different operating systems of different users, and so on. Furthermore, the controls of the online banking websites of different banks are not compatible with each other, and when a user uses for the first time the online banking service of a bank or uses an online banking in a new user side environment, the prompting of installing the security control always pops up automatically during the process of operating the browser. Some browsers (for example IE) cannot directly perform the installing of security controls, but the user needs to click on the yellow strip notification on the upper part of the screen to allow the installing, to smoothly complete the operation of installing the security control. In addition, many online banking websites, after the operation of installing the security control finishes, can be continuously used only after the user refreshes the page. If a user is an USBkey client, the user needs to download and install a different control according to the different brand of USBkey, and often is required to restart the browser after the control installation finishes to make the security control functional. However, often at that time the sheets that jump from other websites may possibly become ineffective, and thus a new order number is required to be generated, which is very troublesome.

### SUMMARY OF THE INVENTION

The technical problem that the present disclosure seeks to solve is to provide a method of visiting an online banking website and a browser, wherein the method, by detecting on a browser side a webpage requesting information of a page website address, before the page on the browser jumps to an online banking website, in advance downloads and installs on the browser the security control relevant to the online banking website, which solves the problems that when an online banking website is operated the security control needs to be in addition downloaded and installed, and that after the installation it is needed to refresh the page or restart the browser, which is inconvenient in operation.

In order to solve the above problem, the present disclosure provides a method of visiting an online banking website, comprising: detecting on a browser side a webpage requesting information of a page website address; determining by the browser that the page website address is a website address information of an online banking website in an online banking website configuration file of the browser, wherein the online banking website configuration file comprises the website address information of the online banking website and its corresponding security plug-in information; the browser, according to the corresponding security plug-in information, initiating downloading of a corresponding security plug-in on the online banking website; and installing the downloaded security plug-in on the browser side, and visiting the online banking website by using the installed security plug-in.

The present disclosure further provides a browser, adapted to visit an online banking website. The browser comprises a storing module, a monitoring module, a controlling module, a downloading module and an installing module. The storing module saving an online banking website configuration file, wherein the online banking website configuration file comprises the website address information of the online banking website and its corresponding security plug-in information. The monitoring module is configured to detect a webpage requesting information of a page website address. The controlling module is coupled to the storing module and the monitoring module, configured to visit the online banking website according to the website address information and configured to receive a detecting result of the monitoring module, and determine whether the page website address is the website address information of the online banking website in the online banking website configuration file. The downloading module is coupled to the controlling module, configured to, according to the determining result of the controlling module and the corresponding security plug-in information in the storing module, initiate downloading of the corresponding security plug-in on the online banking website. The installing module is coupled to the downloading module and the controlling module, configured to execute an installing program of the security plug-in, so that the controlling module can visit the online banking website by the installed security plug-in.

The present disclosure further provides a computer program, comprising computer readable code, wherein when the computer readable code is running on a terminal device, causes the terminal device to execute the method of visiting an online banking website described above.

The present disclosure further provides a computer readable medium, in which the computer program described above is stored.

Compared with the prior art, the present disclosure can obtain the following technical effects:

According to the method of visiting an online banking website and the browser of the present disclosure, the webpage requesting information of the online banking website, before being sent to the corresponding online banking server, is intercepted on the browser side, and before the current page of the browser jumps to the page of the online banking website, the operations of downloading and installing the security control of the online banking website is performed in advance, so that the browser can directly visit the online banking website via the installed security control after completing the page jumping. Because the operations of downloading and installing the security control are completed before entering the online banking website, the tedious procedures of downloading and installing are not needed when the online banking website is visited, and thus the operation of refreshing the page or restarting the browser is not needed. In addition, the operations of downloading and installing the security control are automatically completed on the browser side, so when a user operates a plurality of different online banking websites, the user does not need to individually download and install the security controls. Therefore the method has a great convenience, and largely promotes the security when using online banking websites.

The above description is only an overview of the technical solutions of the present disclosure. In order to understand the technical means of the present disclosure more clearly, and to implement them according to the contents of the description, and in order to make the above and other objects, features and advantages of the present disclosure more fully understood, the specific embodiments of the present disclosure are provided below.

### BRIEF DESCRIPTION OF DRAWINGS

Other advantages and benefits will become clear to a person those skilled in the art by reading the detail description of preferable embodiments below. The drawings are only for the purpose of illustrating the preferable embodiments, and are not considered as limitation to the present disclosure. Furthermore, throughout the drawings, the same reference signs denote the same elements. In the drawings:

FIG. 1 is the block schematic representation of the browser of an embodiment of the present disclosure;

FIG. 2 and FIG. 3 are the flow charts of the first method embodiment of the present disclosure;

FIG. 4 is the flow chart of another method embodiment of the present disclosure;

FIG. 5 is the flow chart of some method embodiment of the present disclosure;

FIG. 6 is the flow chart of the second method embodiment of the present disclosure;

FIG. 7 schematically shows the block diagram of the terminal device for executing the method according to the present disclosure; and

FIG. 8 schematically shows the storage unit for maintaining or carrying the program code for implementing the method according to the present disclosure.

### DETAILED DESCRIPTION OF PREFERRED EMBODIMENTS

The embodiments of the present disclosure will be in detail described with reference to the attached drawing and the examples below, in order to understand sufficiently how the present disclosure applies technical means to solve the technical problem and achieve the technical effects and implement that accordingly.

For example, the description and the claims use some words to represent specific components. A person skilled in the art should understand that, hardware manufacturers may utilize different names to refer to the same component. The present description and the claims do not distinguish the components by the differences in the names, but take the difference in the functions of the components as the distinguishing criteria. For example, the “comprise”, which is used throughout the description and the claims, is an open wording, and thus should be interpreted as “include but are not limited to”. “Approximately” means that, within a receivable range of error, a person skilled in the art can solve the technical problem in a certain range of error, and basically reach the technical effect. Furthermore, the words “couple” or “electrically connect” herein include any means of direct and indirect electrical coupling. Therefore, if the context describes that a first device is coupled to a second device, it means that the first device may be directly electrically coupled to the second device, or be coupled to the second device indirectly via another device or a coupling means. The description will sequentially describe preferable embodiments for implementing the present disclosure; however, the description is for the purpose of explaining the general principle of the present disclosure, rather than limiting the scope of the present disclosure. The protection scope of the present disclosure shall be defined by the attached claims.

It should be explained that, the terms “include”, “comprise” or any other variants thereof are meant to cover nonexclusive including, so that processes, methods, articles or systems that include a series of elements do not only include those elements, but also include other elements that are not explicitly listed, or include the elements that are inherent of such processes, methods, articles or systems. Where there is not more limitation, the elements that are defined by the wording “comprise a . . . ” do not exclude additional the same elements that are present in the processes, methods, articles or systems that comprise the elements.

### Description of the Embodiments

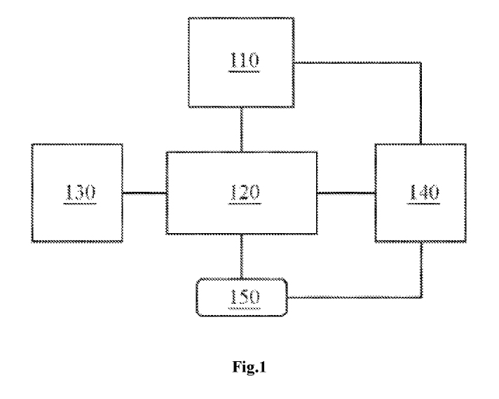

As shown in FIG. 1, a browser 10 disclosed by the embodiments of the present disclosure is adapted to visit online banking websites, the online banking websites may be various online banking websites or other websites that have website address information for logging in those online banking websites on their browsing pages, for example shopping websites or other websites that involve logging in with a user account, wherein the browser 10 exchanges information with the online banking servers corresponding to the online banking websites via the Internet.

The browser 10 disclosed by the present embodiment comprises a storing module 110, a controlling module 120, a monitoring module 130, a downloading module 140 and an installing module 150. The storing module 110 saves an online banking website configuration file, wherein the online banking website configuration file at least records a website address information of the online banking website and its corresponding security plug-in information, and can also selectively record an online banking name, an online banking website address and an online banking logo corresponding to the online banking website, an identification information for determining whether the corresponding security plug-in information has been installed, an access path of the security plug-in, a corresponding backup of the security plug-ins that has been installed on the browser side or a combination thereof.

The controlling module 120 is coupled to the storing module 110 and the monitoring module 130, wherein the monitoring module 130 is for detecting a webpage requesting information of a page website address, wherein the page website address is associated with an online banking website, and can be the website address of the current page on the browser 10, the website address of the target page to be jumped to soon, or a website address information on the current page associated with a page of the online banking website and the like. The controlling module 120 is for receiving a detecting result of the monitoring module 130, and if the monitoring module 130 detects the webpage requesting information of the page website address, the controlling module 120 further, according to the online banking website configuration file, determines whether the page website address is the website address information of the online banking website in the online banking website configuration file; if yes, the controlling module 120 visits the corresponding online banking website according to the website address information; and if not, the controlling module 120 controls the current page of the browser 10 to jump to a target page corresponding to the website address of the webpage.

The downloading module 140 is coupled to the controlling module 120 and the storing module 110, for, according to the determination result of the controlling module 120 and the security plug-in information in the online banking website configuration file, initiating downloading of a corresponding security plug-in on the online banking website, wherein when the controlling module 120 determines that the page website address is the website address information of the online banking website in the online banking website configuration file, the downloading module 140 executes on the browser side the program of downloading the security plug-in. The installing module 150 is coupled to the downloading module 140 and the controlling module 130, for executing a corresponding installing program after the security plug-in is downloaded, so that the controlling module 130 can visit the corresponding online banking website by the installed security plug-in. In addition, regarding the visiting to online banking websites, the controlling module 130 loads on the browser 10 an online banking webpage corresponding to the above page website address, and then visits the online banking webpage, wherein the loading mode of the online banking webpage can be performed in an independent webpage process or in a sandbox, in order to ensure security.

Furthermore, in some embodiments of the present disclosure, before the above installing module 150 executes the installing program, the controlling module 120 further checks whether the current installation environment is safe; if yes, the installing module 150 executing the operation of installing the downloaded security plug-in; and if not, the controlling module 120 pops up on an installation page of the browser a corresponding warning window, as a user interface for performing updating operation of a security level of the installation environment, which enables the user to perform relevant operations of the browser 10 in a safe environment, and ensures the security during operating the online banking website. Likewise, in another embodiment of the present disclosure, the controlling module 120 is further for performing security scanning to the page website address, and displaying a scanning result on the current page of the browser 10, so that the user can determine, according to the scanning result, whether to continue to visit the page website address, thereby improving the security of the operation of visiting the page website address.

Further, in some embodiments of the present disclosure, the controlling module 120 firstly executes encrypting program to the user information of an online banking website that has been visited, and then saves the encrypted information into the storing module 110, and when the browser visits the same online banking website again, the controlling module 120 decrypts and fills the saved encrypted information, and then logs in the online banking website that has been visited according to the decrypted and filled encrypted information, thereby simplifying the procedure of the operation of logging in the online banking website.

Meanwhile, regarding the online banking website that has been visited, the controlling module 120 writes its website address information and the corresponding security plug-in information into the online banking website configuration file, and when the browser visits the same online banking website again, the online banking website configuration file is read from the storing module 110, wherein before a reading operation or writing operation of the online banking website configuration file, the controlling module 120 firstly performs a signature operation processing to the reading operation or writing operation, to obtain permission of the reading operation or writing operation.

Following that, regarding the online banking website that has been visited, the monitoring module 130 accesses initiatively with a preset frequency to an online banking server of the online banking website to detect whether there is a security plug-in of updated version, for example executing immediately upon the startup of the browser or executing after a preset numbers of days, and when a security plug-in of updated version is detected, the controlling module 120 transmits an updating message to the downloading module 140, so as to access to the online banking server to download the security plug-in of updated version, to enable the installing module 150 to replace the installed security plug-in with the security plug-in of updated version, to enable the controlling module 120 to visit the online banking website with the security plug-in of the newest version; and on the contrary, if not, the downloading module 140 does not need to perform the operation of downloading the security plug-in.

The method of visiting an online banking website of the present disclosure will be further described in the following with reference to some method embodiments.

As shown in FIG. 2, the method of visiting an online banking website disclosed by the first method embodiment of the present disclosure comprises the following steps:

Step S110, detecting on a browser side a webpage requesting information of a page website address;

Step S120, determining by the browser that the page website address is a website address information of an online banking website in an online banking website configuration file of the browser;

Step S130, the browser, according to the corresponding security plug-in information, initiating downloading of a corresponding security plug-in on the online banking website; and

Step S140, installing the downloaded security plug-in on the browser side, and visiting the online banking website by using the installed security plug-in.

Referring to FIG. 1 and FIG. 2, in the method of visiting an online banking website disclosed by the first method embodiment of the present disclosure, firstly, the method detects on the browser side whether the current page has a webpage requesting information of a certain page website address, wherein the webpage requesting information may be a log-in website of the online banking website that the user directly inputs on the current page of the browser 10 or be generated by a search engine performing a page jumping. At this time, the browser 10, before jumping to a corresponding webpage according to the page website address, detects by the monitoring module 130 that the current page has webpage requesting information (Step S110), and transmits the detecting result to the controlling module 120. At this time, the controlling module 120 on the one hand parses the content of the page website address, and on the other hand reads from the storing module 110 the website address information of the online banking website recorded in the online banking website configuration file, and judges by comparison whether the two are the same; if yes, the browser 10 determines that the page website address that initiates the webpage requesting information on the current page is the website address information of the online banking website recorded in the configuration file (Step S120), and accordingly performs the subsequent operation of downloading a security control; and on the contrary, if not, the browser 10 determines that the page website address has no relation with an online banking website, and thus according to the content of the page website address jumps from the current page to a corresponding target page.

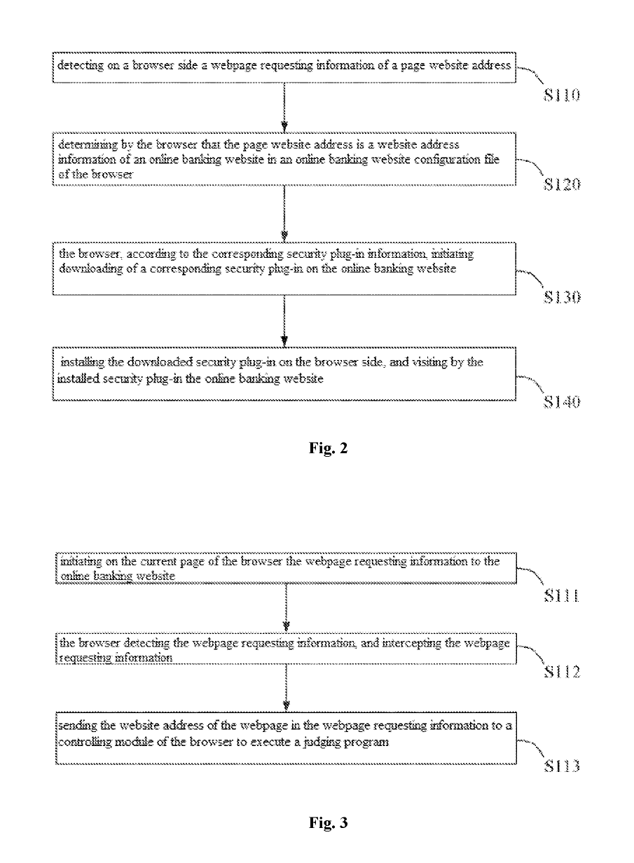

Therefore, in the above operation, when detecting the webpage requesting information of the page website address, the webpage requesting information is firstly intercepted by a detecting module of the browser 10, and sent to the controlling module 120 to execute the judging program. As shown in FIG. 1 to FIG. 3, that is, in Step S110, if the page website address is the website address information of the online banking website, its detailed operation procedure may be but not limited to: initiating on the current page of the browser 10 the webpage requesting information to the online banking website (Step S111), wherein the initiating mode of the webpage requesting information may be popping up, in the current page of the browser 10, a confirming window corresponding to the website address information of the online banking website, and then triggering by the confirming window, for example triggering by the user clicking on the confirming window, but not limited to that. In addition, the request, at the same time when initiated, is detected by the monitoring module 130 of the browser 10, and the webpage requesting information is intercepted (Step S112), and then the website address of the webpage in the webpage requesting information is sent to the controlling module 120 to execute the comparing and judging program (Step S113).

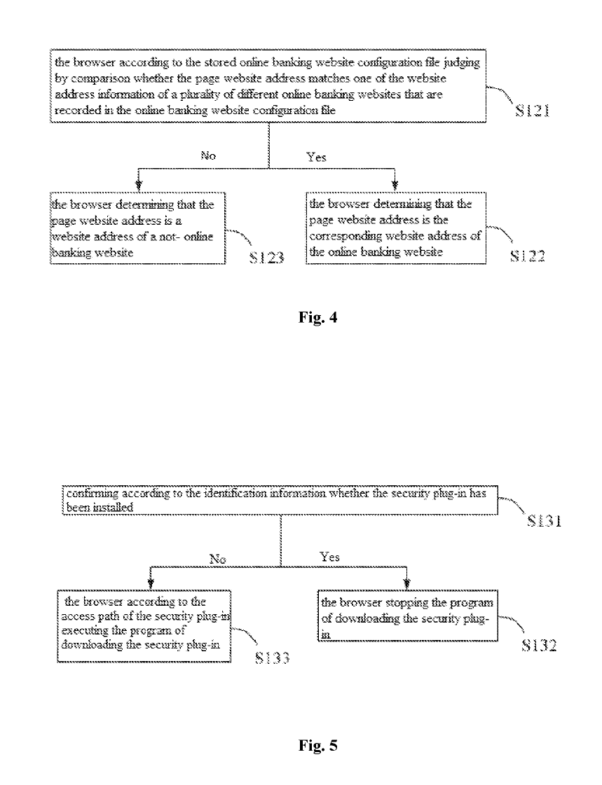

Furthermore, regarding the comparing and judging of the page website address, the website address information of the online banking website recorded in the configuration file may be the website address information of one or more specific online banking websites, and may also be the website address information of all the existing online banking websites in the present. Therefore, as shown in FIG. 1 and FIG. 4, in another method embodiment of the present disclosure, if the configuration file records the website address information of a plurality of online banking websites, then in the relevant operation of the browser 10 judging the page website address, the browser 10 compares the page website addresses according to the website address information of the plurality of different online banking websites recorded in the online banking website configuration file, so as to determine whether the page website address matches one of the website address information of a plurality of different online banking websites (Step S121); if yes, the browser 10 determines that the page website address is the website address information of the corresponding online banking website (Step S122); and if not, the browser 10 determines that the page website address is a website address information of a not-online banking website (Step S123).

Following that, in the method of visiting an online banking website disclosed by the first method embodiment of the present disclosure, after the browser 10 determines that the page website address is the website address information of the online banking website, the method further loads on the browser 10 an online banking webpage corresponding to the page website address, wherein the loading operation may be performed in an independent webpage process, and the online banking webpage may also be solely loaded in a sandbox, so as to perform the relevant operations of the online banking webpage in the sandbox, to ensure the security during operation. Furthermore, in other embodiments of the present disclosure, after the online banking webpage is loaded, security scanning is selectively performed on the currently visited page website address, and the scanning result is displayed on the browser 10, to determine whether the currently visited online banking webpage is safe.

Subsequently, the browser 10, according to the corresponding security plug-in information in the online banking website configuration file, initiates by the downloading module 140 the downloading of a correspondent security plug-in of the online banking website (Step S130), and the currently download security plug-in may be a security plug-in of the newest version or all the security plugs-in on the online banking server. Regarding the program of downloading the security plug-in, a prompting window can be popped up on the current page of the browser 10, and then an instruction of confirming the downloading is executed by the prompting window to trigger the program of downloading; or the program of downloading is automatically executed by the downloading module 140 of the browser 10.

It can be understood that, in certain cases, regarding the online banking website that has been visited, the corresponding security plug-in has been installed on the browser side, so, if the above downloading process downloads the security plug-in that has been installed again, not only the downloading process is quite time consuming, but also other resources of the browser are occupied. Therefore, as shown in FIG. 1 and FIG. 5, in some method embodiments of the present disclosure, the method firstly determines, according to the identification information recorded in the online banking website configuration file, whether the security plug-in that is currently to be downloaded has been installed (S131), for example by the controlling module 120 of the browser comparing the identification information with the version of the security plug-in information, the code size, the version information of the relevant file or the relevant registry information and the like. If the comparing result is that the security plug-in has been installed, the downloading module 140 of the browser 10 stops executing the program of downloading the security plug-in; and on the contrary, if the comparing result is that the security plug-in has not been installed, the browser 10, according to the access path of the security plug-in recorded in an online banking website configuration table, downloads the corresponding security plug-in from the corresponding online banking server, for example the security plug-in of newest version. That is, when the security control of the browser side and the security control of the online banking server are the same, the browser 10 stops the program of downloading the security control; and when the security control of the browser side and the security control of the online banking server are different, the browser 10 downloads the newest security control in the online banking server to replace the local security control.

Referring to FIG. 1 and FIG. 2, after the downloading of the security plug-in is completed, the installing module 150 of the browser 10 installs the downloaded security plug-in on the browser side, and then the online banking website is visited by the controlling module 120 using the installed security plug-in (S140). It should be noted that, in the present embodiment, before the operation of installing the downloaded security plug-in, the method can also selectively firstly check whether the current installation environment of the browser 10 is safe; if yes, executes the operation of installing the downloaded security plug-in; and on the contrary, if the checking result has a problem in security, pops up a corresponding warning window on the current page of the browser 10, and performs an updating operation to the security level of the current installation environment by the warning window or other repairing windows relevant to system security, for example, performs upgrading or remedy in security, and then executes the program of installing the security control.

Furthermore, in a method embodiment of the present disclosure, regarding the online banking website that has been visited, the method writes on the browser side the website address information and security plug-in information that have been visited into the online banking website configuration file, wherein regarding the reading operation or writing operation of the online banking website configuration file, the method firstly performs a signature operation processing to the reading operation or writing operation, and then opens permission of the reading operation or writing operation, which can ensure the integrity of the online banking website configuration file and ensure that the online banking website configuration file will not be maliciously modified.

In addition, regarding the user information of the online banking website that has been visited, the method encrypts and saves the user information on the browser side, and when the browser visits the same online banking website again, firstly decrypts and fills on the browser side the saved encrypted information, and then, according to the decrypted and filled encrypted information, enables the user to directly log in the browser and use the online banking website that has been visited. Meanwhile, the method may also selectively displays on a function option of the browser the online banking name and the online banking logo corresponding to the online banking website that has been visited, to facilitate the user to directly log in the online banking website next time.

Meanwhile, because of the developing of technology and the increasing destructive effect of Trojan horse viruses, the security controls at the online banking server side may be updated anytime. Therefore, in some method embodiments of the present disclosure, after the downloaded security plug-in is installed on the browser side, the browser accesses initiatively with a preset frequency to an online banking server of the online banking website that has been visited to detect whether there is a security plug-in of updated version, for example each time when the browser connects to the Internet, or each time when the browser detects a webpage requesting information of the online banking website that is to be jumped to. If the browser detects that the online banking server has a security plug-in of updated version, the browser initiatively downloads the security plug-in of updated version from the online banking server, and replaces the installed security plug-in with the security plug-in of updated version, so that the security plug-in of the browser side maintains in the status of security plug-in of the newest version anytime, to prevent Trojan horse virus or other malicious software from initiating possible attacking to the client. On the contrary, if the browser does not find out a security plug-in of updated version, that indicates that the currently security plug-in installed in the browser side is a security plug-in of the newest version, and therefore the browser does no action.

Following that, because the detecting and updating of the version of the security plug-in on the browser side is performed in the background of the browser, during the process of the detecting and updating, the operations of the user normally operating the computer system or visiting a website by the browser are not interfered. Such an updating does not need to log in an online banking page, can be completed on the browser side, and does not need the manual executing by the user, and therefore has quite a good convenience.

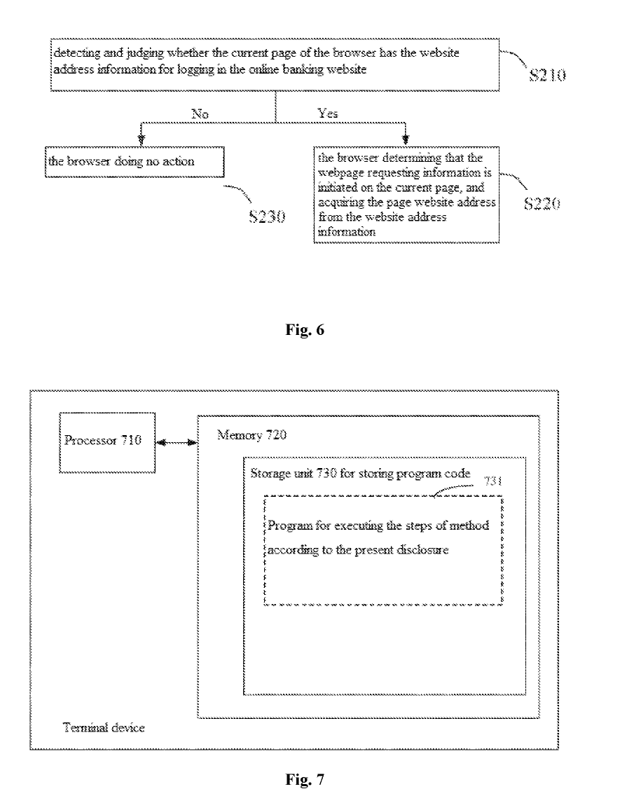

As shown in FIG. 6, the second method embodiment disclosed by the present disclosure is approximately the same as the first method embodiment as to the method of visiting an online banking website, and their difference is that, in the method of visiting an online banking website disclosed by the first method embodiment, the webpage requesting information is generated by the user directly inputting the log-in website address of the online banking website on the current page of the browser 10 or by executing a page jumping by a search engine, while in the second method embodiment, the browser judges, according to the current webpage environment, whether the webpage requesting information is to be initiated. Therefore, in the method of visiting an online banking website disclosed by the second method embodiment of the present disclosure, the operation of detecting on a browser side a webpage requesting information of a page website address comprises:

Step S210, detecting and judging whether the current page of the browser has the website address information for logging in the online banking website.

That is, the method detects whether the current page of the browser has the website address information for logging in the online banking website. For example, if the current page of the browser side is a page of a shopping website or another page that has the function of on-line payment, the page, in order to facilitate the user to select the payment mode, generally display one or more online banking names or online banking logos, as the entry for logging in the corresponding online banking website. Therefore these entries are all provided with the website address information of the corresponding online banking websites. It is according to the presence of these entries that the browser performs the judging.

Furthermore, during the process of the judging, the browser according to the online banking website configuration file judges whether the page website address in the website address information matches one of the page website addresses of a plurality of different online banking websites; if yes, the browser determines that the current page has the website address information for logging in the online banking website; and if not, the browser determines that the current page has no relation with the website address information for logging in the online banking website. Therefore, after the browser completes the above judging operation, the browser executes according to the judgment result one of the following steps.

Step S220, if yes, the browser determining that the webpage requesting information is initiated on the current page, and acquiring the page website address from the website address information.

Step S230, if not, the browser side doing no action.

In that, after the browser determining that the current page has the website address information for logging in the online banking website, the browser initiatively considers that the current page has one or more webpage requesting information corresponding to the website address information of the online banking website, and acquires the corresponding page website addresses from these website address information. Then, the browser subsequently performs the subsequent operations of downloading and installing a security control. The operations of downloading and installing the security control are approximately the same as those of the above embodiment, and will not be discussed repeatedly here.

On the contrary, when the browser determining that the current page has no relation with the website address information for logging in the online banking website, that indicates that on the current page there is not a demand or motivation to log in an online banking website, and thus the browser does not need to perform the operations of downloading and installing the security control.

In the second method embodiment of the present disclosure, the browser side determines that a user, during the process of the operation of the browser, may possibly have the demand on logging in an online banking website, and downloads in advance the security controls associated with the online banking websites to the browser side, and completes the installing program. Therefore, when the user enters the log-in page of the online banking website via the entry of the online banking website on the current page, the user can immediately perform the operation of logging in the online banking website in a safe environment, so that the operations of manually downloading and installing the security control are omitted and the operation of refreshing the page does not need to be performed.

On the basis of the above, the method of visiting an online banking website disclosed by the present disclosure, before the browsers jumps from the current page to the operating page of the online banking website, has already completed the installing of the security plug-in on the browser side. Therefore, when the page jumps to the operating page of an online banking website or an online banking website, the method can prevent the prompting of the installation of the security control from automatically popping up on the operating page to affect the using of the operating page. Meanwhile, during the process of operation, the installed security control can be normally used without the refreshing of the page, so as to prevent the problem that the sheets that jump from other websites are ineffective, so that the operations on the browser are quite flexible and convenient.

The above description shows and describes several preferable embodiments of the present disclosure; however, as noted earlier, it should be understood that the present disclosure is not limited to the form disclosed herein and should not be deemed as excluding other embodiments, and can be used for various other combinations, modifications and environments. Further, changes can be made within the scope of the concept of the present disclosure herein by the above teachings or techniques or knowledge of relevant fields. Additionally, the changes and variations made by a person skilled in the art are within the protection scope of the attached claims of the present disclosure without departing from the spirit and scope of the present disclosure.

Each component embodiment of the present disclosure may be implemented by hardware, or by software modules that are operated on one or more processors, or by a combination thereof. A person skilled in the art should understand that, some or all of the functions of some or all of the components of the browser according to the embodiments of the present disclosure can be implemented by using a microprocessor or a digital signal processor (DSP) in practice. The present disclosure can also implement apparatus or device programs (for example, computer programs and computer program products) for executing part of or the whole of the method described herein. Such programs for implementing the present disclosure may be stored on a computer readable medium, or may be in the form of one or more signals. Such signals can be downloaded from Internet websites, or provided on a carrier signal, or provided in any other forms.

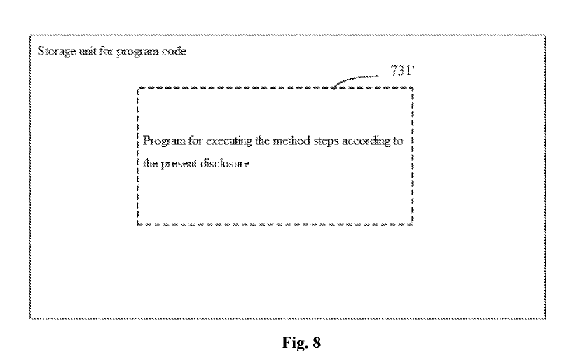

For example, FIG. 7 shows a terminal device that can implement the method of visiting an online banking website according to the present disclosure, such as PC and mobile telephone. The terminal device traditionally comprises a processor 710 and a computer program product or computer readable medium in the form of a memory 720. The memory 720 can be electronic memories such as flash memory, EEPROM (Electrically Erasable Programmable Read Only Memory), EPROM, hard disk or ROM. The memory 720 has the storage unit 730 for the program code 731 for executing any steps of the above method. For example, the storage unit 730 for program code can include program codes 731 for individually implementing each of the steps of the above method. Those program codes can be read from one or more computer program products or be written into the one or more computer program products. Those computer program products comprise program code carriers such as hard disk, compact disk (CD), memory card or floppy disk. Such computer program products are usually the portable or fixed storage unit as shown in FIG. 8. The storage unit may have storage segments or storage spaces with similar arrangement with the memory 720 of the terminal device in FIG. 7. The program codes may for example be compressed in a suitable form. Generally, the storage unit includes a computer readable code 731′, which can be read by a processor like the processor 710. When those codes are running on the terminal device, the terminal device executes each of the steps of method described above.

The “one embodiment”, “an embodiment” or “one or more embodiments” stated herein indicates that, the specific feature, structures or characteristics that are described with reference to the embodiment are included in at least one embodiment of the present disclosure. Furthermore, it should be noted that, the wordings such as “in an embodiment” herein do not necessarily refer to the same embodiment.

In the description provided herein, numerous specific details are described. However, it can be understood that the embodiments of the present disclosure may be practiced without those specific details. In some embodiments, well-known methods, structures and techniques are not shown in detail, in order not to obscure the understanding of this description.

It should be noted that the above embodiments are for describing the present disclosure rather than limiting the present disclosure, and a person skilled in the art may design alternative embodiments without departing from the scope of the appended claims. In the claims, any reference signs between parentheses cannot bring about restriction to the claims. The word “comprise” does not exclude the elements or steps that are not listed in the claims. The word “a” or “an” preceding an element does not exclude the presence of a plurality of such elements. The present disclosure may be implemented by means of hardware comprising several distinct elements and by means of suitably programmed computers. In claims that list several devices, some of those devices may be embodied by the same item of hardware. The words first, second, and third, etc. do not denote any order. These words can be interpreted as names.

Furthermore, it should also be note that, the languages used in the description are selected mainly for the purposes of readability and teaching, rather than for interpreting or limiting the subject matter of the present disclosure. Therefore, various modifications and alterations are apparent for a person skilled in the art without departing from the scope and spirit of the attached claims. Regarding the scope of the present disclosure, the disclosure of the present disclosure is illustrative, rather than restrictive, and the scope of the present disclosure is defined by the attached claims.

1. A method of visiting an online banking website, comprising:
detecting on a browser side a webpage requesting information of a page website address;
determining by the browser that the page website address is a website address information of an online banking website in an online banking website configuration file of the browser, wherein the online banking website configuration file comprises the website address information of the online banking website and its corresponding security plug-in information;
the browser, according to the security plug-in information, initiating downloading of a corresponding security plug-in on the online banking website; and
installing the downloaded security plug-in on the browser side, and visiting the online banking website by using the installed security plug-in.

2. The method according to claim 1, wherein, the online banking website configuration file further comprises: an online banking name, an online banking website address and an online banking logo corresponding to the online banking website, an identification information for determining whether the security plug-in information has been installed, an access path of the security plug-in and a corresponding backup of the security plug-ins that has been installed on the browser side.

3. The method according to claim 2, wherein, after the operation of installing the downloaded security plug-in on the browser side, the method further comprises:
displaying on a function option of the browser the online banking name and the online banking logo corresponding to the online banking website that has been visited.

4. The method according to claim 2, wherein, in the operation of the browser, according to the security plug-in information, initiating downloading of the corresponding security plug-in on the online banking website, the method comprises:
confirming, according to the identification information, whether the security plug-in has been installed;
if yes, the browser stopping executing the program of downloading the security plug-in; and
if not, the browser, according to the access path of the security plug-in, executing the program of downloading the security plug-in.

5. The method according to claim 4, wherein, in the operation of confirming according to the identification information whether the security plug-in has been installed, the browser compares the identification information with a version of the security plug-in information, a code length, a version information of a relevant file or a relevant registry information.

6. The method according to claim 4, wherein, the operation of the browser side, according to the access path of the security plug-in, executing the program of downloading the security plug-in comprises:
popping up a prompting window on a current page of the browser; and
triggering the program of downloading via the prompting window.

7. (canceled)

8. The method according to claim 1, wherein, the operation of the browser side detecting the webpage requesting information of the page website address comprises:
initiating, on the current page of the browser, the webpage requesting information to the online banking website;
the browser detecting the webpage requesting information, and intercepting the webpage requesting information; and
sending the website address of the webpage in the webpage requesting information to a controlling module of the browser to execute a judging program.

9. The method according to claim 1, wherein, the method further comprises:
on the browser side encrypting and saving a user information of an online banking website that has been visited;
when the browser visits the online banking website again, decrypting and filling on the browser side the saved encrypted information; and
logging in the online banking website that has been visited by the browser according to the decrypted and filled encrypted information.

10. The method according to claim 1, wherein, after the operation of installing the downloaded security plug-in on the browser side, and visiting the online banking website by using the installed security plug-in, the method further comprises:
writing on the browser side the website address information of the online banking website that has been visited and its corresponding security plug-in information into the online banking website configuration file; and
the operation of determining by the browser that the page website address is the website address information of the online banking website in the online banking website configuration file of the browser further comprises:
reading the online banking website configuration file by the controlling module of the browser;
wherein before a reading operation or writing operation of the online banking website configuration file, the method firstly performs a signature operation processing to the reading operation or writing operation, and then opens permission of the reading operation or writing operation.

11. The method according to claim 1, wherein, before the operation of installing the downloaded security plug-in on the browser side, and visiting the online banking website by using the installed security plug-in, the method further comprises:
checking whether the current installation environment of the browser is safe;
if yes, executing the operation of installing the downloaded security plug-in; and
if not, popping up on an installation page of the browser a corresponding warning window; and
performing updating operation by the warning window to a security level of the installation environment.

12. The method according to claim 1, wherein, between the operation of determining by the browser that the page website address is the website address information of the online banking website in the online banking website configuration file of the browser and the operation of the browser, according to the security plug-in information, initiating downloading of the corresponding security plug-in on the online banking website, the method further comprises:
performing security scanning to the page website address; and
displaying a scanning result on the current page of the browser.

13. The method according to claim 1, wherein, between the operation of determining by the browser that the page website address is the website address information of the online banking website in the online banking website configuration file of the browser and the operation of the browser, according to the security plug-in information, initiating downloading of the corresponding security plug-in on the online banking website, the method further comprises:
loading on the browser an online banking webpage corresponding to the page website address, wherein the loading of the online banking webpage is performed in an independent webpage process or in a sandbox.

14. The method according to claim 1, wherein, the operation of determining by the browser that the page website address is the website address information of the online banking website in the online banking website configuration file of the browser comprises:
judging on the current page of the browser whether the page website address is the website address information of the online banking website in the online banking website configuration file of the browser;
if yes, executing on the browser side the program of downloading the security plug-in; and
if not, the browser jumping from the current page to a target page corresponding to the website address of the webpage.

15. (canceled)

16. The method according to claim 1, wherein, the operation of the browser side detecting the webpage requesting information of the page website address comprises:
detecting and judging whether the current page of the browser has the website address information for logging in the online banking website;
if yes, the browser determining that the webpage requesting information is initiated on the current page, and acquiring the page website address from the website address information; and
if not, the browser doing no action.

17. (canceled)

18. The method according to claim 1, wherein, in the operation of the browser, according to the corresponding security plug-in information, initiating downloading of the corresponding security plug-in on the online banking website, the security plug-in that is currently downloaded by the browser is the newest security plug-in.

19. The method according to claim 1, after the operation of installing the downloaded security plug-in on the browser side, and visiting the online banking website by using the installed security plug-in, the method further comprising:
the browser accessing initiatively with a preset frequency to an online banking server of the online banking website to detect whether there is a security plug-in of updated version;
if yes, the browser downloading from the online banking server the security plug-in of updated version, and replacing the installed security plug-in with the security plug-in of updated version; and
if not, the browser doing no action.

20. An apparatus for visit visiting an online banking website, applied to a browser, the apparatus comprising a processor for executing instructions stored in a memory, the instructions comprise:
a storing instruction, to save an online banking website configuration file, wherein the online banking website configuration file comprises the website address information of the online banking website and its corresponding security plug-in information;
a monitoring instruction, to detect a webpage requesting information of a page website address;
a controlling instruction, to visit the online banking website according to the website address information and receive a detecting result, and determine whether the page website address is the website address information of the online banking website in the online banking website configuration file;
a downloading instruction, to, according to a determining result and the security plug-in information in the online banking website configuration file, to initiate downloading of a corresponding security plug-in on the online banking website; and
an installing instruction, to execute an installing program of the security plug-in, so that can visit the online banking website by the installed security plug-in.

21. The apparatus according to claim 20, wherein, the online banking website configuration file further comprises: an online banking name, an online banking website and an online banking logo corresponding to the online banking website, an identification information for determining whether the security plug-in information has been installed, an access path of the security plug-in and a corresponding backup of the security plug-ins that have been installed.

22. The apparatus according to claim 20, wherein, the controlling instruction is further to encrypt a user information of the online banking website that has been visited and save the user information, and when the browser visits the online banking website again, the controlling instruction to decrypt and fill the saved encrypted information; and login the online banking website that has been visited according to the decrypted and filled encrypted information.

23.-29. (canceled)

30. A computer readable medium, in which having instructions stored thereon, when executed by at least one processor, cause the processor to perform operations for visiting an online banking website, the operations comprises:
detecting on a browser side a webpage requesting information of a page website address:
determining by the browser that the page website address is a website address information of an online banking website in an online banking website configuration file of the browser, wherein the online banking website configuration file comprises the website address information of the online banking website and its corresponding security plug-in information;
the browser, according to the security plug-in information, initiating downloading of a corresponding security plug-in on the online banking website; and
installing the downloaded security plug-in on the browser side, and visiting the online banking website by using the installed security plug-in.
